(19) United States
(12) Patent Application Publication
(10) Pub. No.: US 2016/0163152 A1
(43) Pub. Date: Jun. 9, 2016

(54) SYSTEMS AND METHODS FOR PRIZE IDENTIFICATION, SELECTION AND COMMUNICATION

(71) Applicant: IGT Canada Solutions ULC, Moncton (CA)

(72) Inventor: Trevor Ko, Unterpremstatten (AT)

(21) Appl. No.: 14/957,868

(22) Filed: Dec. 3, 2015

Related U.S. Application Data
(60) Provisional application No. 62/088,191, filed on Dec. 5, 2014.

(51) Int. Cl. G07F 17/32; G07F 17/34

(52) U.S. Cl. CPC G07F 17/3244; G07F 17/34

(57) ABSTRACT

Systems and methods are provided for receiving player selections of icons and using the player selections to populate a group of potential game outcomes. A display presents a player with groups of icons. The system receives player selections of icons and each player selected icon is assigned an award or prize value and assigned to one or more potential game outcomes. An outcome for the game may be determined from the potential game outcomes and the outcome for the game is visually presented to the player along with the assigned award or prize value and both may be provided to the player.

### RELATED APPLICATIONS AND PRIORITY CLAIM

This application claims the benefit of and priority to U.S. Provisional Patent Application No. 62/088,191, filed Dec. 5, 2014, the disclosure of which is expressly incorporated by reference herein.

### FIELD OF THE INVENTION

The disclosure relates to systems and methods for electronic entertainment machines. In particular, systems and methods are provided for determining, populating and displaying a set of awards that are applied to potential outcomes in a game. Player selections are used to assign awards to potential outcomes in a game and then one of the potential outcomes is selected or identified to the player in a graphic animation that shows the player selected award being applied to the game outcome.

### BACKGROUND

Video slot machines entertain by randomly selecting and displaying symbols to a player and then granting awards to a player based on the occurrence of certain symbol combinations and patterns.

What is desirable, for both the player and the game machine owner or operator, are game machines and methods that increases player interest and enjoyment over previously known machines and methods so as to encourage longer and more frequent game play. These game machines and methods will generate increased revenue through increased play of the gaming machine.

### SUMMARY

New systems and methods for handling and presenting game play are provided herein. In certain embodiments, the systems and methods provide increased player interaction in real-time. The increased player interaction leads to increased player interest and enjoyment and increased game play volume. The systems and methods allow players to make selections and these selections are used to populate or complete a set of possible awards or game outcomes (for instance monetary prizes, multipliers, game credits, free spins or other awards) in the game.

In one embodiment, a gaming system is provided with a controller; a player input device to receive player selections from a player and to provide the player selections to the controller; and a display for displaying a wagering game and providing communications to a player. The controller is operative to receive player inputs from the player input device and to cause the display to present a plurality of icons and other game graphics and information on a display screen. In certain embodiments the plurality of icons are provided in a first group.

For instance, the display screen visually presents the plurality of icons in a first group. The controller may also receive, from the player input device, a selection of one or more icons from the first group. The controller may also determine an award associated with each selected icon and cause the display to visually present each award as a selected award. The controller may also assign each presented award to one or more potential outcomes in the game, the game having a plurality of potential outcomes. The controller may also select or determine an outcome for the game from a plurality of potential outcomes; and cause the display to present the award assigned to the determined outcome for the game.

In one embodiment, the display is a touch sensitive display and the display serves as the player input device. The display shows a plurality of icons from a first group in a first location on the screen and the player selects one or more icons by touching the location of each selected icon on the screen. In response to receiving the player selection of one or more icons from the first group, the display is animated to show the awards associated with the player selected icons in a gaming zone on the display. Each award is then assigned to one or more potential outcomes in a round of the game. One of the potential outcomes is selected as the game outcome and the display screen is animated to reveal the actual outcome corresponding to the potential outcome. Additionally, the gaming zone on the display screen is animated to show the determined outcome for the game and the award assigned to that outcome. For example, following the player selection one of the icons may be animated to show that it is a 2× bonus award. This 2× bonus award is then assigned to one or more potential outcomes in the game. Preferably one award is assigned to each potential outcome for the game and each award is shown in the gaming zone. The outcome for the game is then selected, and the award assigned to that outcome is then applied and the display is animated to show the combination. For instance, if the player selected icon revealed a 2× bonus award, and that award was assigned to the potential outcome that was selected as the game winner in an amount of $100, then the 2× bonus would be applied to the $100 outcome for a $200 game win.

Thus, in certain embodiments, particular graphical effects are animated and shown in response to player selections and/or game events. In particular, the player selection of one or more icons and the responsively associated animation to reveal the awards associated with the player selected icons. Another example is an animation showing assignment of these awards to potential game outcome spaces, for instance, on a wheel, grid, belt, ticker or traditional slot machine reel arrangement. Another example is an animation showing the selection of the winning game outcome from among a plurality of potential game outcomes. Another example is responsive to the selection or receipt of the winning game outcome and is an animation revealing the winning game outcome prize on the display and the application of the player selected award to the winning game outcome.

In another embodiment, a methods and systems for operating a gaming device are provided and include the steps of (or features for) displaying a set of icons in a first group on a display screen and then receiving, from a player, a selection of one or more icons from the first group. The methods and systems then include revealing (visually displaying) an award associated with each selected icon from the first group and assigning each revealed award to one or more potential outcomes in the game, the game having a plurality of potential outcomes. Thus, in one embodiment, the game systems and methods reveal a hidden prize related to the selected icon. The hidden prize or award may be predetermined or it may be determined after the player selection of the icon, for instance, in response to the player selection of the icon.

Optionally, the methods and systems may include revealing (visually displaying) any awards associated with unselected icons, so that the player can see the awards that were not selected. The methods and systems may also include randomly determining an outcome for the game from the plurality of potential outcomes and awarding the award assigned to the determined outcome for the game. The methods and systems may also involve displaying a set of icons in a second group and optionally, sets of icons in third, fourth and other additional groups. Selections of one or more icons from each of the second, third and fourth groups may be received and awards are revealed for each selected icon. Each revealed award is assigned to one or more potential outcomes in the game.

Optionally, the awards associated with the second group of icons may have a greater value than the awards associated with the first group of icons. Optionally, there may be a greater number of awards from the first group of icons than the second group of icons. Optionally, within the first group, the plurality of icons may all be different. Optionally, the icons in the first group may all be different from the icons in the second group. Optionally, the award associated with each icon may be predetermined before receiving the player's selection of one or more icons. Optionally, the award associated with an icon may be determined after receiving the player's selection of one or more icons.

In another option, each award associated with each unselected icon may be revealed. Optionally, the outcome for the game may be determined randomly and may be depicted in the form of spinning a wheel, the wheel having placed thereon each of the plurality of potential outcomes. Optionally, the wheel may be displayed before any awards have been revealed and assigned to any potential outcomes in the game. Optionally, the plurality of potential outcomes may be placed on the wheel so that identical potential outcomes are not adjacent to each other. Additionally, the outcome for the game may be determined or displayed as being determined by identifying a winning space on the wheel and awarding the award assigned to the winning space on the wheel.

Optionally, the outcome for the game may be randomly determined and include identifying a winning location on a grid, belt, ticker or simulated slot machine reel, the grid, belt, ticker or simulated slot machine reel having placed thereon each of the plurality of potential outcomes. Optionally, the grid, belt, ticker or simulated slot machine reel may be displayed before any awards have been revealed and assigned to any potential outcomes in the game.

Thus, in accordance with certain embodiments of these systems and methods, a game player is provided the opportunity to make selections and the player selections become a set of potential outcomes for a game. The game system game then determines an actual game outcome from the set of potential outcomes and presents the game outcome to the player and provides the associated prize or award.

In another embodiment, the system and methods of populating a pool of potential outcomes in a game are applied in a bonus game where the pool of potential outcomes are identified based on one or more player selections. The bonus game may be applied simultaneously with or subsequent to an underlying base game so that an outcome from the bonus game, for instance a multiplier, may be applied to an award from the underlying base game. The bonus game may also be applied simultaneously with or subsequent to a free spins game. For instance, during an underlying base game, a free spins game may be provided responsive to a predetermined game condition. In this instance, the bonus game may be provided simultaneously with or subsequently to both the underlying base game and the free spins game.

It should be appreciated that certain of the systems and methods described herein could be provided in a primary game or a bonus game.

Other objects, advantages and novel features of the present invention will become apparent from the following detailed description of the invention when considered in conjunction with the accompanying drawings.

### BRIEF DESCRIPTION OF THE FIGURES

Certain embodiments of the invention are illustrated in the Figures of the accompanying drawings in which:

FIG. 1 is a block diagram showing components of a game machine according to one embodiment;

FIG. 2 is a perspective view of a game machine according to one embodiment;

FIG. 3 is a flowchart of various steps performed by the processes and systems described;

FIG. 4 is a view of a display illustrating an example embodiment of various features according to one embodiment;

FIG. 5 is a view of a display illustrating an example embodiment of various features according to one embodiment;

FIG. 6 is a view of a display illustrating an example embodiment of various features according to one embodiment;

FIG. 7 is a view of a display illustrating an example embodiment of various features according to one embodiment; and

FIG. 8 is a view of a display illustrating an example embodiment of various features according to one embodiment.

### DETAILED DESCRIPTION

For simplicity and illustrative purposes, the principles of the present invention are described by referring mainly to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the true spirit and scope of the present invention. Additionally, it is contemplated that various features of the embodiments disclosed herein may be combined. Before explaining the disclosed embodiments of the present invention in detail, it is to be understood that the invention is not limited in its application to the details of any particular arrangement shown, since the invention is capable of other embodiments. Throughout this description, certain acronyms and shorthand notations are used. These acronyms and shorthand notations are intended to assist in communicating the ideas expressed herein and are not intended to limit the scope of the present invention. Other terminology used herein is for the purpose of description and not of limitation.

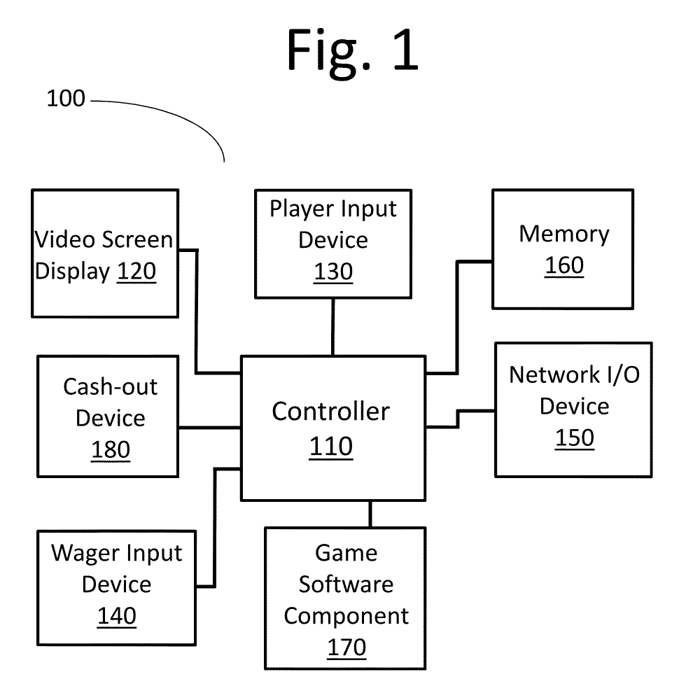

FIG. 1 provides a block diagram of an example game machine, according to an example embodiment of the present invention, showing all of the components in communication, for instance, wired or wireless electronic communication or otherwise coupled so that they can work together. Game device 100 may be a terminal in a distributed system (not shown). Game device 100 has a controller 110 in communication with several peripherals. Game device 100 includes at least one a video screen display 120. The video screen display 120 may be used to show the operation and results of a round of a game, for instance, a slot machine selection game (e.g. showing the movement of icons and their stopping position so that a player can see the game being played and the result). There may be an input device 130, which may be any device which allows the gaming device 100 to accept input from the user, for example, a conventional keyboard, a keypad, a joystick, a mouse, a number of buttons, a touch-sensitive display, a slot machine lever or arm, or a combination of the foregoing. The gaming device 100 may also include a reading device 140. The reading device 140 may be designed, for example, to receive and verify player wagers or accounts, for instance to accept paper bills, or other slips detailing credit, or may be a device which reads magnetically or electronically stored information. For instance, the reading device may read and/or verify a credit or debit account from a credit or debit card or other voucher. Optionally, the reading device 140 may serve as a player tracking card reader, a ticket reader, a banknote detector, a coin detector, or any other input device that can read an instrument supplied by the player for conveying a monetary amount. In the case of a tracking card, the system detects the player's available funds and applies that amount or a selected portion of that amount to the gaming machine being played. The reading device may be an optical reader, a magnetic reader, or other type of reader. A slot may be provided in the gaming machine for receiving the instrument. Additionally, wagers, funds or credits may be transferred electronically for instance, wirelessly with RFID, WiFi, Bluetooth, NFC, tap smart or other processes for instance based on bank account or credit, debit or loyalty card accounts.

The game device 100 may also include a network I/O device 150. The network I/O device 150 may be, for example, a serial port which may connect to a network or telephone line. Alternatively, the network I/O device 150 may be a wireless communications device. The game device 100 may also include memory 160 to store the various graphics and instructions required to operate video screen display 120 and the other functionality described, e.g. network communications; receiving and handling wagers and related information; and determining game outcomes. Additionally, there may be a game software component 170 including terminal interface instructions allowing the terminal to interface with a distributed system or network, in conjunction with the network I/O device 150 or separately. A cash-out device 180 may also be provided to either payout winnings directly to a player or to provide a payment voucher that the player may exchange for cash or other credits at a cashier.

The controller or processor 110 comprises any combination of hardware, software, and/or firmware that may be disposed or provided inside and/or outside of the gaming device 100 that may communicate with and/or control the transfer of data between the gaming device 100 and a bus, another computer, processor, device, service, or network. The controller 110 may include one or a plurality of controllers or processors. The controller 110 in the gaming device 100 may include a CPU, and may alternatively include a CPU in combination with other components, such as I/O circuits and system memory. The controller 110 may reside partially or entirely inside or outside of the device 100.

The network I/O device 150 may connect to an external system such as a gaming network or the Internet (not shown). The external system may include a gaming network, the Internet, other gaming machines, a central controller, a gaming server or other communications hardware and software systems and components.

The game device 100 may communicate with external systems (via hard wires or wirelessly) so the device 100 operates as a “thin client,” having relatively little functionality, a “thick client,” having relatively more functionality, or at a level of functionality therebetween. As a generally “thin client,” the gaming device 100 may operate primarily as a terminal or display device to display the results of gaming outcomes processed externally, for example, on a server as part of networked or external system. In this “thin client” configuration, a central server or controller (which may be referred to as a host system) may execute game software code and determine game outcomes (e.g., with a random or pseudo-random number generator), while the controller 110 on board the gaming machine processes display information to be displayed on the display(s) of the device 100. In an alternative “thicker client” configuration, an external server (known as a host system) determines game outcomes, while the controller 110 on the gaming device 100 executes game code and processes display information to be displayed on the display(s) of the machines. In yet another alternative “thick client” configuration, the controller 110 on the gaming device 100 executes game code, determines game outcomes, and processes display information to be displayed on the display(s) of the machine. Numerous alternative configurations are possible such that these and other functions may be performed within or external to the gaming device 100 as may be necessary or desirable for particular applications.

It should be understood that the gaming devices 100 may take on a wide variety of forms such as a free standing machine, a portable or handheld device primarily used for gaming, a mobile telecommunications device such as a mobile telephone, smart phone or personal daily assistant (PDA), a counter top or bar top gaming machine, or other personal electronic device such as a tablet, a personal computer, laptop, tablet, or other entertainment device.

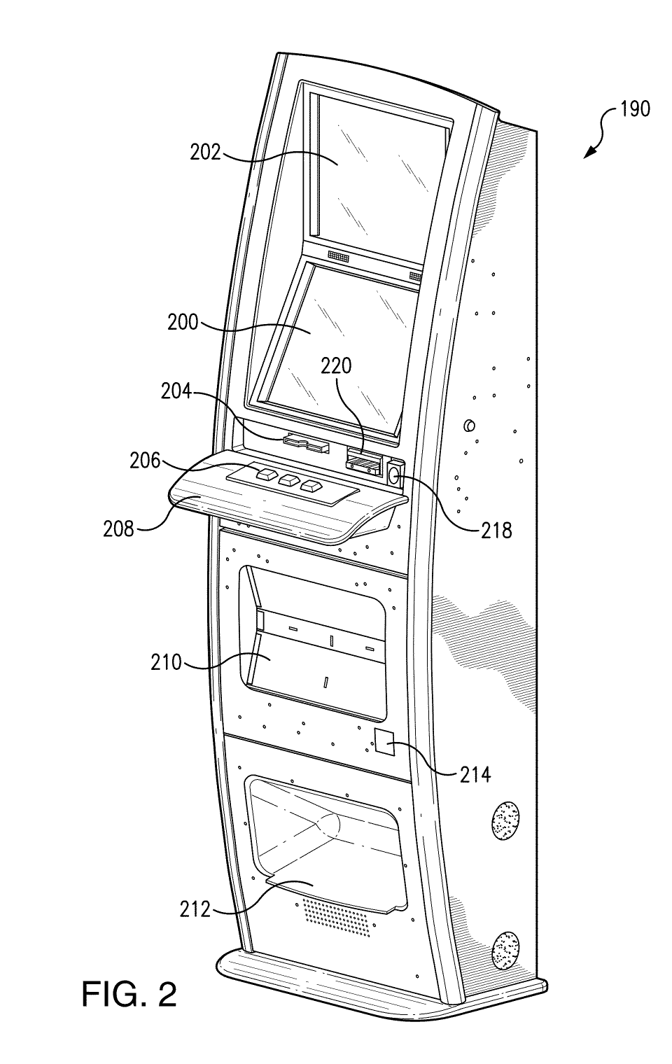

FIG. 2 depicts an exemplary game machine or terminal, according to an example embodiment of the present invention. The video game terminal 190 provides a payout based on a wager and the results of the game. Alternatively, the video game terminal 190 may be configured to provide a game of chance, a lottery game, or another game to the player. For example, the game provided may be played on a display screen. The video game terminal 190 of FIG. 2 includes an upper screen 202 and a display screen 200. The upper screen 202 and display screen 200 may be configured to display information to the player. For example, the upper screen 202 and the display screen 200 may be a film transistor (TFT) display, a liquid crystal display (LCD), a cathode ray tube (CRT), an organic light emitting diode display (OLED) or any other type of suitable display screen. Optionally, the upper screen 202 and/or the display screen 200 may be touch sensitive display screens, allowing a player to input choices by touching areas on the screens. In one embodiment, the actual game play is shown on display screen 200 and the upper screen 202 may be used to provide game identification and other game related information such as paytables, jackpot amounts, recent winnings, game logos or other advertising or information as desired by the game owner or operator.

The video game terminal 190 may include a ticket dispenser 204. The ticket dispenser 204 may be configured dispense a ticket. For example, the ticket may be a lottery game ticket. Alternatively, the ticket may be a prize ticket or voucher redeemable for a prize or any other type of ticket. For example, the ticket may be printed on heavyweight paper. A printer (not shown) may be provided with the ticket dispenser 204.

The video game terminal 190 may include a set of play buttons 206. The play buttons 206 may be configured to accept player input. For example, the play buttons 206 may be used by the player to interact with the wagering game by receiving selections from the player and providing the selections to the wagering game. For example, the player may select a game to be played, a wager amount to be made, and responses to choices provided by the wagering game.

The video game terminal 190 may include a fingerboard 208. The fingerboard 208 may serve as a hand rest for the player while playing the wagering game. The video game terminal 190 may also include a bottom graphics area 210. The fingerboard 208 and the bottom graphics area 210 may include printed graphics that attract player attention to the game or other visual designs. The fingerboard 208 and the bottom graphics area 210 may also include printed information, such as game information or prize information.

The video game terminal 190 may include a foot rest 212. The foot rest 212 may be configured to accept the player's feet in a resting position while playing at the video game terminal.

The video game terminal 190 may include a coin dispenser 214. The coin dispenser 214 may be configured to dispense coins. For example, the coin dispenser 214 may dispense coins as change for a player's wager or a player's winnings. Alternatively, the coin dispenser 214 may be replaced with, or provided in addition to, a ticket dispenser. A player's winnings may be dispensed as a ticket which may later be redeemed at a cashier.

The video game terminal 190 may include a coin acceptor 218. The coin acceptor 218 may be configured to accept a coin. For example, the coin may be legal tender in the form of a coin or legal tender equivalents, such as tokens provided by a gaming establishment.

The video game terminal 190 may include a bill acceptor 220. The bill acceptor 220 may be configured to accept a legal tender in the form of a bill. Alternatively, the bill acceptor 220 may be configured to accept legal tender equivalents, such as bills provided by a gaining establishment. Alternatively, the bill acceptor 220 may be configured to accept a magnetic card. For example, the magnetic card may include a currency-equivalent balance. Alternatively, the bill acceptor may be configured to accept and/or read and verify other currency-equivalents such as credit cards, debit cards and the like.

The embodiments described herein involve numerous hardware components such a video game system (such as the video game terminal 190 of FIG. 2 or the game device 100 of FIG. 1), computing devices, processors, memory, input and output devices, displays, networks, electronic gaming terminals, and networked systems including these components. These components and the combinations thereof may be configured to perform the various functions described herein. Accordingly, the embodiments described herein are directed towards electronic machines and connected systems that are configured to process and transform electromagnetic signals representing various types of information. The embodiments described herein pervasively and integrally relate to machines, systems, and their uses; and the embodiments described herein have no meaning or practical applicability outside their use with computer hardware, machines, various hardware components, and connected systems, as appropriate.

Substituting the video game system, computing devices, processor, memory, and display for non-physical components, using mental steps for example, substantially affects the way the embodiments work, likely rendering them inoperable.

The computer hardware components and other features are essential elements of the embodiments described herein, and they cannot be omitted or substituted with mental means without having a material effect on the operation and structure of the embodiments described herein. The computer hardware is essential to the embodiments described herein and is not merely used to perform steps expeditiously and in an efficient manner.

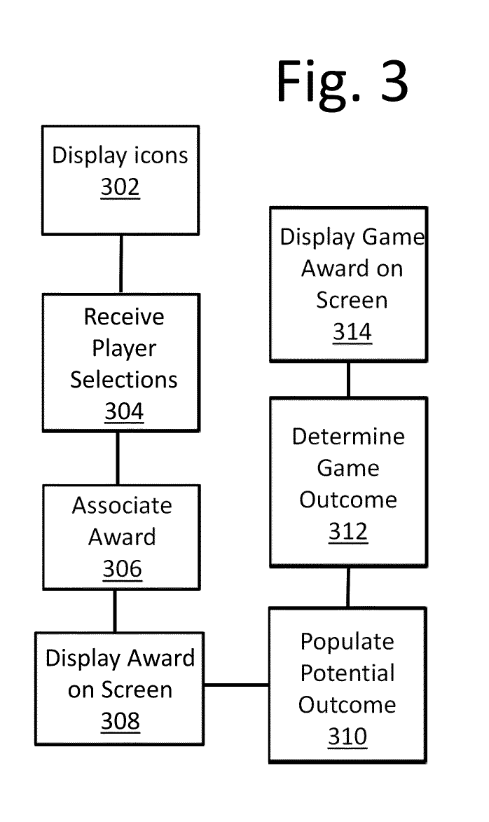

FIG. 3 shows the steps of a method that may be performed in accordance with certain embodiments and systems of the invention. The method is performed by the video gaming system, using hardware components of the video game system. More particularly, a controller, such as a processor, is configured to perform the method of FIG. 3. In one embodiment, the controller causes a player to be presented with a plurality of sets of icons 302, for instance on the display screen 200, each icon representing a yet unidentified award or prize value. The player enters selections of icons from the plurality of sets of icons using a player input device 130. As each player selection of an icon is received 304 by the player input device 130, the player input device provides the player selection to the controller 110. The controller 110 may be a suitably programmed processor that is configured to perform the functions described herein, working, for instance, with the game software component 170.

The controller 110 associates an award with each selected icon 306. The controller may randomly determine the award associated with each selected icon, or the award associated with each selected icon may be predetermined. Thus, the video gaming system may include a random selector such as a random or pseudo-random number generator which may be used by the controller 110 when selecting an award to associate with an icon. In embodiments in which the award associated with the selected icon is predetermined, computer memory may be used to store an assignment of awards to icons.

The controller also causes the display to show each award to the player on the display and to assign each presented award to one or more potential outcomes in the game, the game having a plurality of potential outcomes. In this way, the controller receives the player selections of icons, associates and, optionally, determines an award for each icon, causes the display to present each award to the player on the display 308 and then populates a potential outcome from each of the awards 310. Accordingly, the controller populates a set of potential outcomes based on the player selections and random or predetermined prizes and awards associated with the player selected icons. In one embodiment, the controller associates or assigns each prize or award associated with the selected icon to a group of potential game outcomes. The assignment of awards to outcomes may be performed by updating computer memory associated with the video gaming system.

The controller also determines an outcome for the game 312 from the plurality of potential outcomes or, alternatively, the outcome may be predetermined or may be provided by a central controller, for instance in the case of a networked game machine or system. The controller may determine the outcome for the game 312 independently or it may receive an outcome from a separate controller, for instance a central controller in the case of a networked game machine. The controller causes the display to show 314 the game prize or game award assigned to the determined outcome for the game.

Optionally, the controller may cause the system to provide the player with a prize or award associated with the selected icon, for in the form of a payment, game credits or a ticket or voucher that may be exchanged for payment.

Thus, in this manner, the player selections are used to populate a group of potential game outcomes. The presentation of the game play is extended and made more exciting and enjoyable for the player. The player experiences having a significant impact on the game outcome when compared against traditional games.

In certain embodiments, any one or more of the operations described above as being performed by a controller may be performed by a central gaming server or controller that is external to a video gaming machine, for instance a central gaming server or controller that is networked or otherwise in communication with the controller of a video gaming machine. Additionally, the operations described above as being performed by a controller may be performed by a combination of central gaming server or controller that is external to a video gaming machine along with a controller internal to a gaming machine. Thus, for instance, game outcome determinations or identities of icons selected by players may be determined internally or externally to a gaming machine.

In embodiments involving a networked central gaming server or controller that is external to a video gaming machine, a communication or series of communications or other data exchanges may be performed to facilitate authentication of a player or player account; verification of a game outcome or prize result or manner of displaying a game outcome to a player, or verification of the status of a gaming machine, for instance to ensure that the gaming machine is identified, authenticated, and properly connected to the network in a secure manner.

These embodiments may include a communication or series of communications between a networked central gaming server or controller that is external to a video gaming machine and a controller internal to the video gaming machine. For instance, the networked central gaming server or controller may periodically ping the video gaming machine and await a proper response from the video gaming machine to ensure that the video gaming machine is online and properly verified and/or authenticated. If the proper response is not received, the central gaming server or controller may disable the video gaming machine or generate and send an alert signal. In another embodiment, the video gaming machine may communicate to the networked central gaming server or controller that a player has entered a wager or other input indicating a desire to play a game. Responsive to receipt of this communication, the networked central gaming server or controller may then determine an outcome or may simply return an authorization instruction to the video gaming machine to proceed with a game. Additionally, the networked central gaming server or controller may provide instructions or commands to the video gaming machine on a specific manner or how to display the game to the player or what to display and animate. In some embodiments, the networked central gaming server or controller may provide instructions or commands to the video gaming machine on which icons to display following a player selection of icons. Additionally, or alternatively, the networked central gaming server or controller may provide instructions or commands to the video gaming machine on the outcome of the game and/or how to display the game outcome or what to display and animate. The networked central gaming server or controller may also provide instructions or commands to the video gaming machine on how to animate the screen or on player account data or winnings. During these processes, the video gaming machine may provide responses, instructions or other data to the networked central gaming server or controller that confirm receipt of instructions or commands from the networked central gaming server or controller or that provide status updates for instance status updates indicating progress of the game or presentation thereof. Additionally, or alternatively, the video gaming machine may provide instructions or other data to the networked central gaming server or controller that provide indications of player selections or inputs or outcomes determined by the video gaming machine.

In one embodiment each of the plurality of sets of icons are presented, by the controller via the display, to the player separately in time and/or in a separate location on the display.

In one embodiment after presentation of an award associated with the player selected icon, the system causes the display to show the awards that were associated with any unselected icons.

In one embodiment, multiple groups of icons are presented on the display screen. The first group of icons presented to the player represent or can only be associated with or are only associated with a relatively low reward when compared against the other groups of icons. The second group of icons may represent a higher reward level when compared against the first group of icons. A third group of icons may represent a reward higher than the second group of icons. This pattern may continue with the fourth, fifth and any further groups of icons.

In another embodiment the type of award varies between the first, second, third, fourth and any additional groups of icons. For instance, one group may only yield an additional spin as an outcome. Another group may yield free spins, either in identical or varying numbers. Another group may yield free credits, either in identical or varying numbers. Another group may yield a multiplier, either in identical or varying amounts. Another group may yield a monetary prize, either in identical or varying amounts.

The award may be applied in a subsequent game and that subsequent game may be the same game or a different game. For instance, where the award is a free spin, free credit, or multiplier, that award may be applied against an outcome in a separate game.

In one embodiment, the second group of icons may be associated with the same or greater or fewer outcomes than the first group of icons. The third group of icons may be associated with the same or greater or fewer outcomes than the second group of icons. The fourth group of icons may be associated with the same or greater or fewer outcomes than the third group of icons and so on, so that each progressive group of icons may be associated with the same or greater or fewer outcomes than the previous group of icons.

In one embodiment the first group of icons may be associated with the greatest number of potential outcomes in the game and the second group of icons is associated with the second greatest number of potential outcomes in the game and the third group of icons is associated with the third greatest number of potential outcomes, the fourth group of icons is associated with the fourth greatest number of potential outcomes and so on. In this embodiment each successive group of icons is associated with fewer potential outcomes than the previous group of icons.

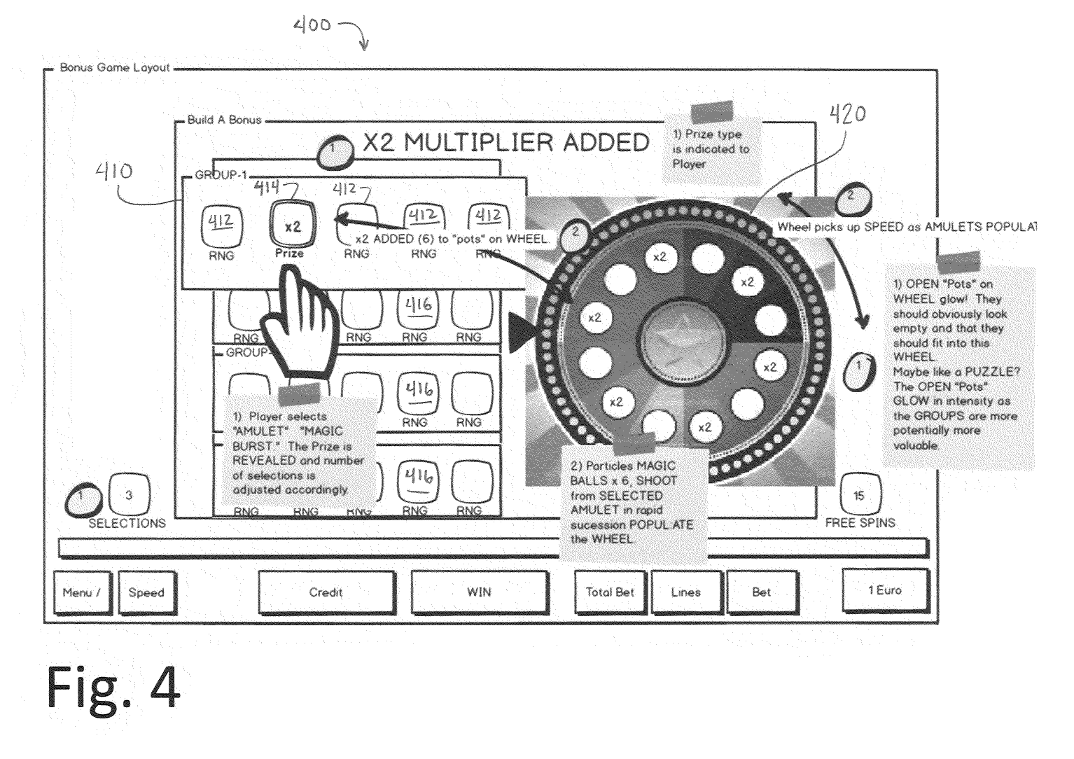

FIGS. 4-7 show an embodiment of the inventive concepts, however, it is to be understood that these inventive concepts have broad application and are not to be limited the particular embodiment shown. FIG. 4 shows a screen shot 400 of a display showing a game. A first group of icons, Group-1 410 is enlarged to show that it is the current group from which the player is making a selection. In the current display, Group-1 410 shows four unselected icons 412. A fifth icon 414 has been selected by the player and converted to show an associated award, in this case the award shown is a 2× multiplier. Additional unselected icons 416 appear in Groups 2-4.

The screen shot 400 shows that the 2× multiplier award 414 has been used to populate 6 positions as potential outcomes (each marked “×2”) on the game outcome wheel 420. As shown, at this point, the game outcome wheel is not entirely populated as it shows 6 positions with potential outcomes that have not yet been determined.

Optionally, at this point the display might show the prizes that were associated with any of the unselected icons 412 from Group-1 410. Additionally, the system might animate the game outcome wheel 420 so that as the potential outcomes on the game outcome wheel 420 are populated, the game outcome wheel 420 spins faster and faster. Additionally, the system might animate the game outcome wheel 420 so that as the potential outcomes on the game outcome wheel 420 are populated, the game outcome wheel 420 highlights these potential outcomes with bright or flashing colors or other indicators.

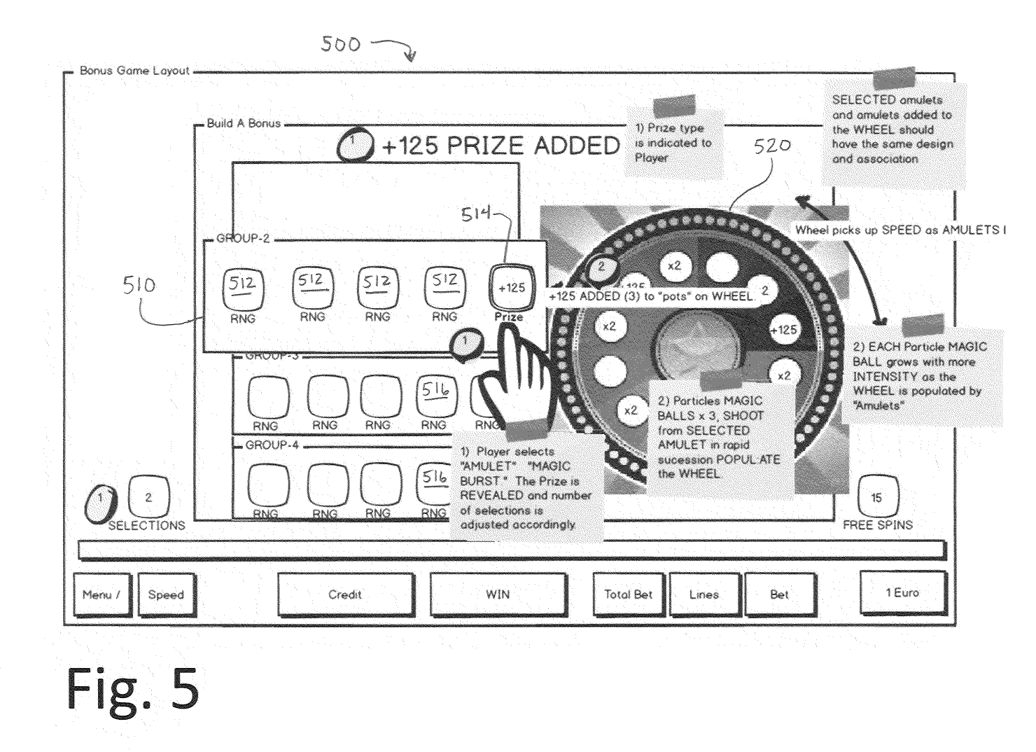

FIG. 5 shows a screen shot 500 of the display of FIG. 4 after a further progression of the game. A second group of icons, Group-2 510 is enlarged to show that it is the current group from which the player is making a selection. In the current display, Group-2 510 shows four unselected icons 512. A fifth icon 514 has been selected by the player and converted to show an associated award, in this case the award shown is a +125 prize award. Additional unselected icons 516 appear in Groups 3-4.

The screen shot 500 shows that the +125 prize award 514 has been used to populate 3 positions as potential outcomes (each marked “+125”) on the game outcome wheel 520. As shown, at this point, the game outcome wheel is still not entirely populated as it shows 3 positions with potential outcomes that have not yet been determined.

Again, at this point the display might optionally show the prizes that were associated with any of the unselected icons 512 from Group-2 510. Additionally, the system might animate the game outcome wheel 520 with increasing speed in view of the increasing number of potential outcomes on the game outcome wheel 520 that are populated. Additionally, the system might animate the game outcome wheel 520 to highlights populated potential outcomes with bright or flashing colors or other indicators.

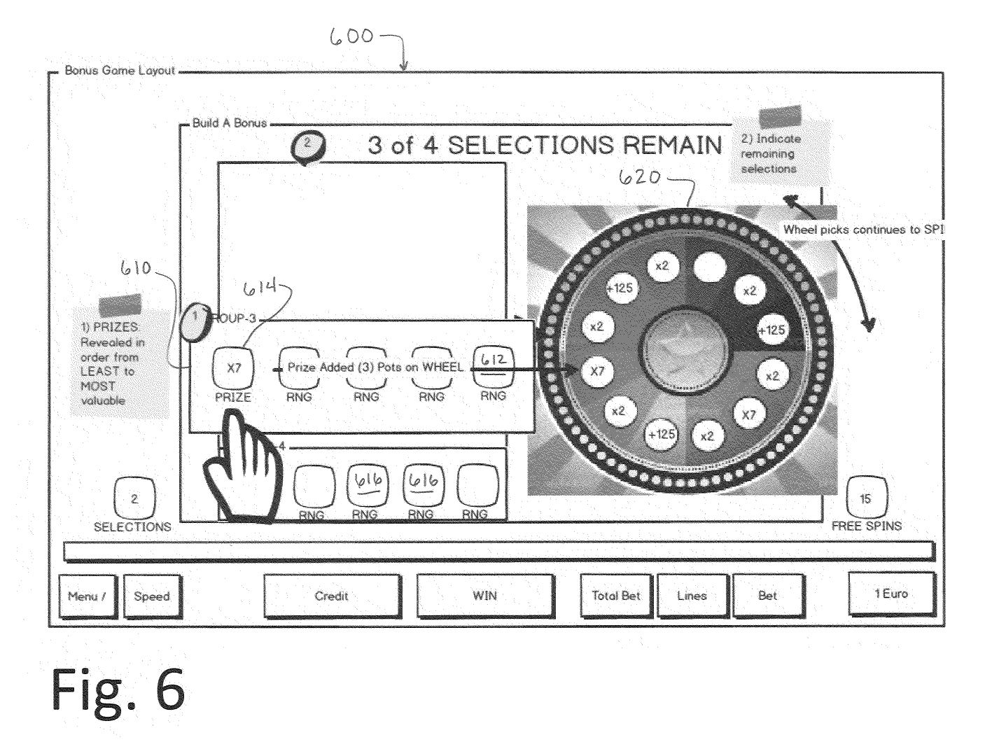

FIG. 6 shows a screen shot 600 of the display of FIG. 5 after a further progression of the game. A third group of icons, Group-3 610 is enlarged to show that it is the current group from which the player is making a selection. In the current display, Group-3 610 shows four unselected icons 612. A fifth icon 614 has been selected by the player and converted to show an associated award, in this case the award shown is a 7× multiplier award. Additional unselected icons 616 appear in Group 4.

The screen shot 600 shows that the 7× multiplier award 614 has been used to populate 2 positions as potential outcomes (each marked “×7”) on the game outcome wheel 620. As shown, at this point, the game outcome wheel is still not entirely populated as it shows 1 positions with potential outcomes that have not yet been determined. As can be appreciated from the sequence of FIGS. 4-6, in this embodiment, the prize amount increases or changes from Group 1 to Group 2 to Group 3. Additionally the number of positions on the game outcome wheel populated by a prize amount decreases with each successive Group. In particular, six positions were filled from Group 1; three positions were filled from Group 2 and two positions were filled from Group 3.

Again, at this point the display might optionally show the prizes that were associated with any of the unselected icons 612 from Group-3 610. Additionally, the system might animate the game outcome wheel 620 with increasing speed in view of the increasing number of potential outcomes on the game outcome wheel 620 that are populated. Additionally, the system might animate the game outcome wheel 620 to highlights populated potential outcomes with bright or flashing colors or other indicators.

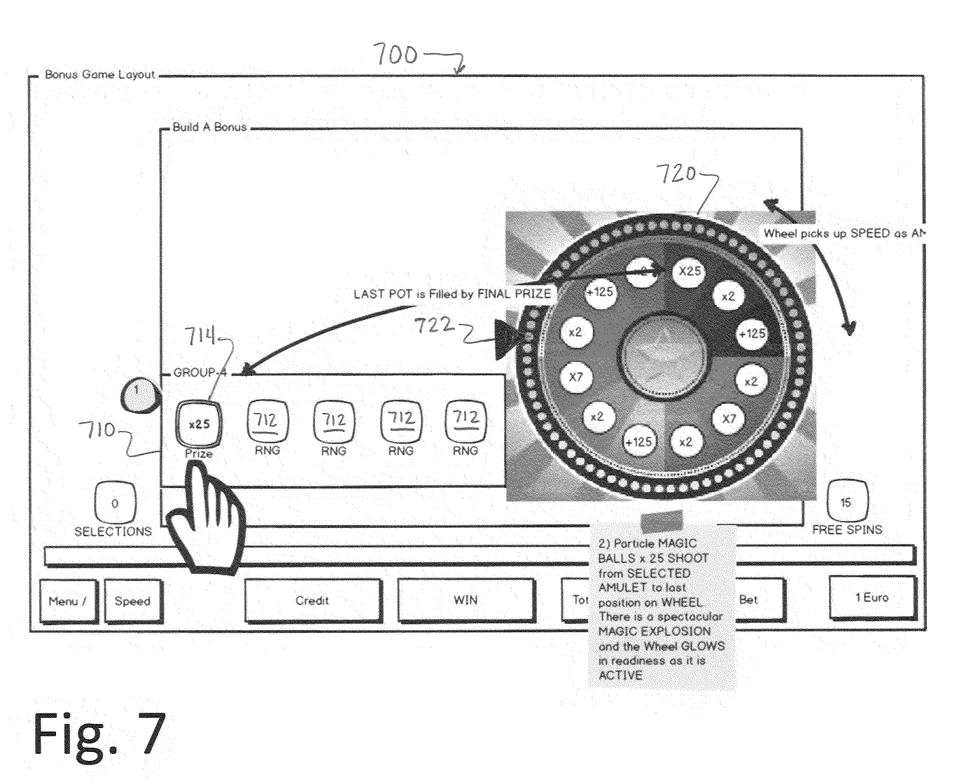

FIG. 7 shows a screen shot 700 of the display of FIG. 6 after a further progression of the game. A fourth group of icons, Group-4 710 is enlarged to show that it is the current group from which the player is making a selection. In the current display, Group-4 710 shows four unselected icons 712. A fifth icon 714 has been selected by the player and converted to show an associated award, in this case the award shown is a 25× multiplier award.

The screen shot 700 shows that the 25× multiplier award 714 has been used to populate one position as potential outcome (marked “×25”) on the game outcome wheel 720. As shown, at this point, the game outcome wheel 720 is entirely populated as each of the positions has been provided a potential outcome.

Again, at this point the display might optionally show the prizes that were associated with any of the unselected icons 712 from Group-4 710. Additionally, the system might animate the game outcome wheel 720 with increasing speed in view of the increased number of potential outcomes on the game outcome wheel 720 that are populated. Additionally, the system might animate the game outcome wheel 720 to highlight the populated potential outcomes with bright or flashing colors or other indicators and also to indicate that the game outcome wheel 720 is fully populated.

Once the game outcome wheel 720 is fully populated it might spin for a predetermined or random length of time or a player may cause the game outcome wheel 720 to spin through use of the player controls. The determined outcome for the game may be shown with marker 722 and the game machine may issue credit or voucher to the player.

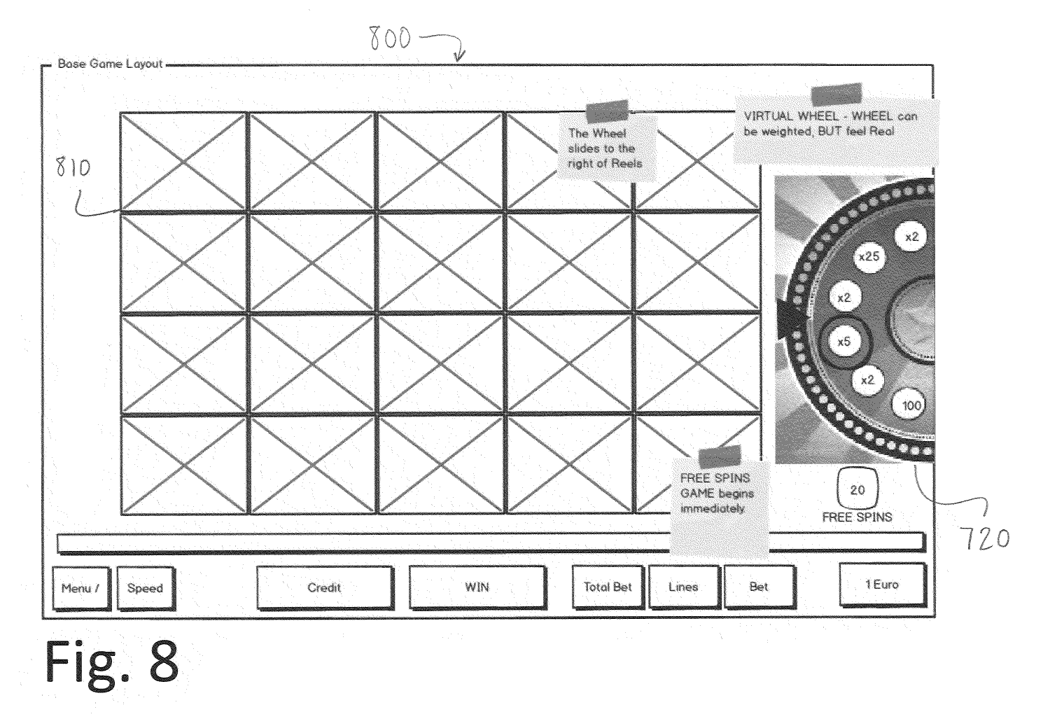

In one embodiment shown in FIG. 8, the system for using player selections to populate a pool of potential game outcomes may be used along with a base game, such as a traditional slot machine game or other video wagering game. In such an embodiment once the game outcome wheel 720 is populated, the game outcome wheel 720 may be used for a number of outcomes of a separate or linked base game.

FIG. 8 depicts a screen shot 800 that follows FIG. 7, where the game outcome wheel 720 is shifted off to the side and a base game 810 is featured more prominently. For instance, the base game may involve presentation and animation of a traditional slot machine type of game. The system may then provide the player the base game 810 and after a round of the base game 810, the game outcome wheel 720 may spin and a bonus or other prize determined from the game outcome wheel 720 may be applied against the outcome from the base game 810. Thus, the 5× multiplier shown on the game outcome wheel 720 in FIG. 8 may be applied to an outcome from a round of the base game.

Subsequently, the system may then provide the player the base game 810 again and after another round of the base game 810, the system may spin or allow the player to spin the game outcome wheel 720 to determine a bonus to be applied with this round of the base game 810.

In another embodiment, animation of the game outcome wheel 720 is simultaneous with animation of the base game 810, so that when any reels or symbols are animated in the base game, the game outcome wheel 720 is made to spin. The animation in the base game and the spinning of the game outcome wheel 720 may then stop at or about the same time and any prize or multiplier provided by the game outcome wheel 720 is applied against the outcome in the base game.

In another embodiment, the game outcome wheel 720 is provided with a free spins game, where the free spins game commences during a separate base game. For instance, responsive to a trigger condition during the base game a free spins game is provided to the player. The outcome in the free spins game may be modified by a result obtained from the game outcome wheel 720, after awarding the resulting prize from the free spins game, the game system may then return to the base game.

The number of outcomes that the game outcome wheel 720 may be used can be predetermined or it may be randomly determined in conjunction with populating the game outcome wheel 720 or at another point during game play. For instance, after using the system described above to populate the game outcome wheel 720, the system may randomly determine that the populated game outcome wheel 720 can be used for a number of future rounds of the base game, for instance two round. Optionally, the populated game outcome wheel 720 may be used until the end of the game play session or until a player indicates a desire to repopulate the game outcome wheel 720. Optionally, the populated game outcome wheel 720 may be used for a predetermined number of rounds of the base game.

In another option, game outcome wheel 720 is only used after a trigger condition occurs in the base game. Thus, responsive to satisfying a trigger condition, for instance a particular variety or size of win, or a number of wins or losses in a row, or an accumulation of wins, losses or credits, the system may spin the game outcome wheel 720 or allow the player to input an instruction to spin the game outcome wheel 720. Such an instruction might be in the form of a “Bonus Spin” button or the like.

In another option, a trigger condition as described above allows the player to reset the game outcome wheel 720 and make new selections for populating the game outcome wheel 720 with potential award outcomes. For instance, responsive to satisfying a trigger condition such as a particular variety or size of win, or a number of wins or losses in a row, or an accumulation of wins, losses or credits, the base game may cause the system to present the player with the selection screens described above and then use the player selections to repopulate the game outcome wheel 720.

While the exemplary embodiment are depicted above, it can be appreciated by a person of skill in the art that the concepts are not limited to the use of a wheel and that any suitable arrangement for housing or depicting the pool of potential game outcomes would be suitable. For instance, it would be possible to use a grid, belt, ticker or simulated slot machine reel to display and show the pool of potential game outcomes.

The gaming system has been described above as a dedicated physical gaming machine such as might be provided in a casino or other establishment. Alternatively, the gaming machine may be a suitable computer or mobile device (smartphone, tablet, etc.) connected to a network or server via the internet and configured and programmed to carry out and provide the inventive concepts described herein. The gaming machine may be a screen image in a virtual casino. Icon selection and other player inputs may be by touch screen, a mouse, a joystick, keyboard, buttons or other input device. The gaming system may access a gaming site or a social website (e.g., Facebook) via the internet, wherein a remote gaming site controls various aspects of the game and allows remote players to participate in games using a virtual gaming machine. The player's inputs may be transmitted to a remote server and the results displayed to the display screen on the player's computer or mobile device. For example, a player's mobile computing system (e.g., a smartphone) may detect winning symbol combinations by signals from the server informing the computing system that a winning combination has occurred. Alternatively, the remote server may provide instructions to the player's mobile computing system regarding what should be displayed. For gaming via the internet, the wagering may be by credit card or with an online account. Awarding the player may be by crediting the player's account. For portable computing devices, Near Field Communications (NFC), such as Bluetooth, or WiFi may be used by a player computing device to communicate with an actual or virtual gaming machine.

Accordingly, in some embodiments, one or more servers may be configured to perform at least some of the steps described in FIG. 3. For example, a server, may be remotely connected with a client device such as a computer, mobile device or slot machine. The server includes a processing system (e.g. a processor) which is configured with processor-executable instructions which configure the processor to perform at least some of the steps described in FIG. 3 and the accompanying written disclosure. In at least some embodiments, the client device acts as a simple client in that it adopts a passive role by acting as an input mechanism and display device without performing all steps described in FIG. 3. Instead, some of the steps of may be performed by a remote or centralized server or controller. For example, the associating awards, populating the potential outcome and determining the game outcome may be performed by the server's processor, which communicates with the client device. In such embodiments, the server may then cause the client device to generate displays on the display system associated with the client device. For example, in at least some embodiments, the server may control the movement and appearance of the icons and other features of the game, for instance wheels. (e.g., it may select the stopping position of the wheel and thus the outcome of the game) and may provide instructions to the client device to instruct the client device to display corresponding display screens. Similarly, in some embodiments, the server may select awards associated with player selected icons as well as icons that are not selected by the player and the server may instruct the client device to display those icons and the awards on the display. The server may also cause the display to show the pool of potential game outcomes being populated with the awards associated with the player selected icons.

Additionally, the server may cause the display to show a virtual selection of a game outcome from the pool of potential game outcomes. For instance, the display may show a virtual spinning wheel, the wheel having placed thereon the pool of potential game outcomes. The server causes the display to animate the wheel, giving it the appearance of a spinning wheel. After spinning, the wheel stops and the actual game outcome is indicated by the stopped position of the wheel on the display.

Accordingly, the server and the client device together form a multi-nodal system which may collectively perform the steps described with FIG. 3. In embodiments in which a server is used to perform many of the steps described in FIG. 3, the server may require a memory for storing game data, such as the replacement symbols.

Those skilled in the art may write the appropriate software to carry out the invention without undue experimentation.

The term “random” used herein refers to pure random as well as pseudo-random.

While particular embodiments of the present invention have been shown and described, it will be appreciated by those skilled in the art that changes and modifications may be made without departing from this invention in its broader aspects and, therefore, the appended claims are to encompass within their scope all such changes and modifications as fall within the true spirit and scope of this invention. Any of the features described herein may be combined into a game.

What is claimed is:

1. A video gaming system comprising:
a display for displaying a wagering game;
a player input device to receive player selections;
a memory;
a programmed controller, in communication with the display, the player input device and the memory, the controller configured to:
cause the display to show a plurality of icons in a first group on a display screen;
receive, from the player input device, a selection of one or more icons from the first group;
determine an award associated with each selected icon from the first group;
animate the display to show each award associated with each selected icon from the first group;
cause the display to show a plurality of icons in a second group on the display screen;
receive, from the player input device, a selection of one or more icons from the second group;
determine an award associated with each selected icon from the second group, wherein the controller is configured so that the awards associated with the second group of icons have greater value than the awards associated with the first group of icons;
animate the display to show each award associated with each selected icon from the second group;
determine an outcome for the game from the plurality of potential outcomes; and
animate the display to show the award assigned to the determined outcome for the game.

2. The gaming system of claim 1, further comprising a wager input device for receiving a wager.

3. The gaming system of claim 1, wherein the game has a greater number of revealed awards from the first group of icons than the second group of icons.

4. The gaming system of claim 1, wherein within the first group of icons the plurality of icons are all different.

5. The gaming system of claim 1, wherein the icons in the first group are all different from the icons in the second group.

6. The gaming system of claim 1, wherein the award is a multiplier.

7. The gaming system of claim 1, wherein the award is a prize amount.

8. The gaming system of claim 1, wherein the award is one or more game credits.

9. The gaming system of claim 1, wherein the award is one or more free spins.

10. The gaming system of claim 1, wherein the award associated with each icon is predetermined before receiving the selection of one or more icons.

11. The gaming system of claim 1, wherein the award associated with an icon is determined after receiving the selection of one or more icons.

12. The gaming system of claim 1, wherein the display is a touch sensitive display and the display serves as the player input device and the display shows the plurality of icons in a first location and in response to receiving the player selection of one or more icons from the first group; animating the display to show the awards associated with the player selected icons in a gaming zone on the display so that each award is assigned to one or more potential outcomes; and, in response to determining an outcome from the plurality of potential outcomes, animating the gaming zone to show the determined outcome for the game and the award assigned to that outcome.

13. The gaming system of claim 1, further comprising;
revealing each award associated with each unselected icon.

14. The gaming system of claim 1, wherein the controller is configured to randomly determine an outcome for the game comprises spinning a wheel, the wheel having placed thereon each of the plurality of potential outcomes.

15. The gaming system of claim 14, wherein the controller is configured to display the wheel before any awards have been revealed and assigned to any potential outcomes in the game.

16. The gaming system of claim 14, wherein the controller is configured to cause the display to show the plurality of potential outcomes on the wheel so that identical potential outcomes are not adjacent to each other.

17. The gaming system of claim 1, wherein the controller is configured to randomly determine an outcome for the game by identifying a winning location on a wheel, grid, belt, ticker or simulated slot machine reel, the wheel, grid, belt, ticker or simulated slot machine reel having placed thereon each of the plurality of potential outcomes.

18. The gaming system of claim 17, wherein the controller is configured to cause the display to show the wheel, grid, belt, ticker or simulated slot machine reel before any awards have been revealed and assigned to any potential outcomes in the game.

19. A system comprising:
a client device including a display and a player input; and
a server in communication with the client device, the server including a memory and a processing system coupled with the memory, the processing system configured to:
cause the display to show a plurality of icons in a first group on a display screen;
receive, from the player input, a selection of one or more icons from the first group;
determine an award associated with each selected icon from the first group;
animate the display to show each award associated with each selected icon from the first group;
cause the display to show a plurality of icons in a second group on the display screen;
receive, from the player input device, a selection of one or more icons from the second group;
determine an award associated with each selected icon from the first group, wherein the controller is configured so that the awards associated with the second group of icons have greater value than the awards associated with the first group of icons;
animate the display to show each determined award;
assign each shown award to one or more potential outcomes in the game, the game having a plurality of potential outcomes;
determine an outcome for the game from the plurality of potential outcomes; and
animate the display to show the award assigned to the determined outcome for the game.
